(19) United States
(12) Patent Application Publication
(10) Pub. No.: US 2025/0348086 A1
(43) Pub. Date: Nov. 13, 2025

(54) PASSIVE ACOUSTIC LOCATING OF THE DRONE BY USING GROUND MICROPHONE ARRAY

(71) Applicant: Microavia International Limited, Dublin (IE)

(72) Inventors: Dmitry POPOV, Dubai (AE); Enrique PLAZA, Dubai (AE)

(21) Appl. No.: 18/659,517

(22) Filed: May 9, 2024

(51) Int. Cl. G05D 1/654; G01S 5/00; G01S 5/20; G01S 5/28; G05D 109/25; H04R 1/40

(52) U.S. Cl. CPC G05D 1/6545; G01S 5/009; G01S 5/20; G01S 5/28; H04R 1/406; G05D 2109/25; H04R 2201/401; H04R 2430/20

(57) ABSTRACT

A navigation system for airborne vehicles without GNSS data uses at least three microphones positioned at or near a base station. The microphones capture sounds emitted by the airborne vehicle and these sounds are processed to calculate the vehicle's location. The vehicle then makes a series of maneuvers in response to the information received from the base station.

### TECHNICAL FIELD

The invention relates to the area of unmanned aerial vehicles (UAVs) and systems that increase UAVs operation safety. More specifically, the invention relates to systems and methods for landing drones when satellite coordinates are unavailable.

### BACKGROUND

GNSS (Global Navigation Satellite System) significantly influences how airborne drones land. GNSS affects drone positioning during landing. With accurate GNSS data, drones can land at precise locations. This is useful because drones often need to land at a specific spot, such as a landing pad or a charging station.

Many modern drones are equipped with automated landing systems that rely on GNSS. A drone uses GNSS data to navigate back to its point of origin or another designated landing site. In situations where a drone encounters an issue (like low battery or loss of signal), GNSS allows the drone to land safely. The drone can use its last known GNSS coordinates to find a suitable nearby area for landing, minimizing the risk of damage or accidents. GNSS coordinates are used throughout a landing. For example, data from GNSS data is processed by autopilots along with inertial measurement unit (IMU) data, altimeter data, and compass data. For drones equipped with advanced navigation systems, terrain data can be integrated to assist in safe landings. The drone can therefore adjust its path to account for slopes or uneven terrain, ensuring stability. GNSS integration with onboard systems allows drones to adjust their landing approach in real-time based on environmental factors. For example, a drone might alter its descent path or speed to accommodate strong winds. GNSS enables geofencing, which can designate safe landing zones. The use of such zones ensures that drones do not land in restricted or unsafe areas and comply with regulatory and safety requirements.

Because GNSS depends on satellite signals, any disruption in these signals can affect a drone's ability to land safely. Thus, a drone's reliance on GNSS signals can become problematic when GNSS signals are not available. For example, GNSS can be interfered with by the environment, such as tall buildings in cities or areas with dense foliage. Intentional disruption of GNSS signals can also occur. Loss of reliable GNSS signals can risk both drone security and operational safety. To mitigate these risks, new technologies are needed to assist drone navigation even when GNSS data lacks sufficient reliability for precise maneuvers.

### SUMMARY

Navigational assistance is provided to an airborne vehicle, such as a drone, by way of a microphone array located at or near a base station. The airborne vehicle emits sounds that are captured by the microphones and used to calculate the vehicle's position and direction. This position data is received by the vehicle in-flight, and the vehicle incrementally adjusts its position in response to data the vehicle receives.

For example, a method is disclosed of airborne vehicle navigation that works by emitting sound from a source associated with the airborne vehicle to at least three microphones installed at or proximate a landing site. Signals are emitted from the sound source for collection by the at least three microphones. The at least three microphones are logically connected with a computing device having a processor and nonvolatile storage. The computing device calculates the location of the airborne vehicle relative to the landing site using the 3-dimensional position of the sound source determined by the signals collected by the at least three microphones. The calculated relative location is received at the airborne vehicle, which executes maneuvers to decrease the distance between the airborne vehicle and the landing site in response to the calculated relative position. In a further embodiment, the vehicle executes further maneuvers in response to receiving a recalculated relative position of the airborne vehicle. The recalculated position results from the output of the microphones after the vehicle has completed its first set of maneuvers.

Multiple sound sources can be used for navigation. For example, in an embodiment, the sound source is a first sound source with a first sound signature and the airborne vehicle comprises a second source with a second sound signature, distinct from the first sound signature. The position of the vehicle is calculated by comparing the relative position of the first and second sound sources. The airborne vehicle can also have three or more sound sources that are spaced apart from each other such that the position of the airborne vehicle can be calculated from the relative positions of the at least three sound sources. In some embodiments, therefore, the received location of the airborne vehicle is calculated from a plurality of sound sources emitted from the airborne vehicle.

In an embodiment, the vehicle's emitted signals can be captured by one or more microphones configured as a pair with another, proximate microphone. A three-microphone embodiment can also be deployed in a configuration with two pairs where one “pair” has a single microphone. In such configurations the signals captured by each pair of microphones can be processed jointly to improve data quality. For example, given three microphones A, B, and C positioned proximate to each other, possible pairs are AB, AC, BC.

Transmission of information to the airborne vehicle, including location information, is accomplished by way of a radio, a light, or a sound signal.

The airborne vehicle's propulsion system can be used for navigation by capturing, with the microphones, sound signals from the airborne vehicle after a change in control parameters of the propulsion system. In another variation, the airborne vehicle's sound source comprises a sound signature, and information received by the airborne vehicle comprises an identifier specific to the airborne vehicle's sound signature.

An exemplary system for assisting navigation of an airborne vehicle using a sound source associated with the airborne vehicle is also disclosed. The system includes a group of at least three microphones, with a known vector representing the 3-dimensional relative position of the microphones to a designated 3-dimensional location such as a landing site, a charging station, either contact or contactless, an observation position, or a target, for capturing signals from the sound source. A computing device with a processor and nonvolatile storage is logically connected to the group of at least three microphones and configured for calculating a 3-dimensional position of the sound source in relation to the group of at least three microphones. The computing device is further configured for calculating the location of the airborne vehicle relative to the landing site using the 3-dimensional position of the sound source. A communicator, instructed by the computing device, transmits the calculated relative location to the airborne vehicle. The airborne vehicle is configured to make maneuvers to decrease the distance between the airborne vehicle and the landing site in response to the calculated relative position sent by the communicator.

In an embodiment, the group of microphones and the designated target, for example, the landing site, are stationary or are mounted on a moving vehicle such as a truck or a railroad car.

In an embodiment, several groups of microphones form a grid.

Options and variations in the system can be implemented similar to the exemplary method. For example, the sound source can be a first sound source with a first sound signature and the airborne vehicle comprises a second source with a second sound signature, distinct from the first sound signature, and the computing device is configured to calculate the position of the vehicle by comparing the relative position of the first and second sound sources. Or at least three sound sources are spaced apart from each other such that the position of the airborne vehicle can be calculated from the relative positions of the at least three sound sources. In these embodiments, the system's computing device is configured to calculate the position and direction of the airborne vehicle from a plurality of sound sources emitted from the airborne vehicle. Other shared features include an embodiment where microphones are configured to work in pairs such that signals captured by each pair of microphones are averaged or combined.

An alternative method of assisting navigation of an airborne vehicle is also disclosed that focuses on assisting navigation from a base station near a landing site or takeoff site. This method also relies on a sound source associated with the airborne vehicle and at least three microphones installed at or proximate to the landing site. The steps include capturing, using the at least three microphones, signals from the sound source. This is followed by determining, by a computing device with a processor and nonvolatile storage logically connected to at least three microphones, a 3-dimensional position of the sound source. The computing device then calculates the location of the airborne vehicle relative to the landing site using the 3-dimensional position of the sound source and communicates the calculated relative location to the airborne vehicle. The communication includes instructions for the airborne vehicle that allow calculation of maneuvers to decrease the distance between the airborne vehicle and the landing site in response to the calculated relative position.

In implementation of this method, the position of the airborne vehicle can be iteratively re-calculated by issuing an instruction to the airborne vehicle to move at a direction relative to a known direction of the vehicle, and capturing the output of the microphones after the vehicle has completed the instruction.

As with the systems and methods previously described, multiple sound sources can be used. Sound sources can include using two or three distinct sound sources and calculating the position of the vehicle by comparing the relative position of the first and second sound sources. 18. The method of claim 15, wherein the airborne vehicle comprises at least three sound sources that are spaced apart from each other. The microphones can also be configured as pairs as described above.

In an alternative embodiment, instructions for the airborne vehicle are calculated by the computing device using a neural network previously trained on navigation data collected from airborne vehicles.

### BRIEF DESCRIPTION OF THE DRAWINGS

FIG. 1 is a block diagram of an exemplary system comprising a base station and an approaching drone.

FIG. 2 is a block diagram of an alternative exemplary system comprising a base station and an approaching drone with a plurality of sound sources.

FIG. 3 is a block diagram of an alternative exemplary system comprising a base station with a two-tier microphone configuration in relation to an approaching drone with a plurality of sound sources

FIG. 4A are top, side, and perspective views of an exemplary base station configured with a plurality of microphones.

FIG. 4B is a block diagram of a base station configured with exemplary three-microphone configurations.

FIG. 4C is a block diagram of an alternative exemplary embodiment of a base station configured with four microphones.

FIG. 4D is a block diagram of an exemplary configuration of four microphones on a base station.

FIG. 4E is a block diagram of an exemplary configuration of four microphones with sub-optimal microphone placement.

FIG. 5 is a block diagram of an example of signal processing by an exemplary base station configured with a plurality of microphones.

FIG. 6 is a flow diagram of an exemplary method of using the disclosed systems for drone navigation.

FIG. 7 is an illustration of a two-dimensional projection of three-dimensional half-hyperboloids (in space) or half-parabolas (on plane) to illustrate SRP PHAT based on Time Difference of Arrival (TDOA).

FIG. 8 is an illustration of hyperbola intersections in two dimensions.

FIG. 9 is a diagram illustrating bi-spheric correction for finding the location of a sound source.

FIG. 10 is a diagram of a special case when the 3D curved surfaces are degraded to the plane.

FIG. 11 is an illustration of a sound source point equidistant from 3 microphones.

### DETAILED DESCRIPTION

Vehicles are positioned in 3-dimensional space capable of conducting sound waves such as air or water. The relative position of a vehicle in 3-dimensional space is determined by an array of microphones positioned near or on a landing platform. The relative position is communicated to the vehicle and the information is used to guide the vehicle to the designated landing site.

Vehicles emit sounds during normal flight operations. Some vehicles have only one propulsion mechanism such as coaxial helicopters or floating devices with one propeller. Others have multiple propulsion mechanisms, such as two-rotor helicopters, quadcopters, or two-propeller floating devices. Other sound sources associated with the vehicle, such as a buzzer, can also be present. For example, a vehicle can have a buzzer that emits a sound with a dynamic signature specific to that vehicle.

A drone designated landing site (DLS) is a specific area designated for the safe landing of drones. The term DLS is often used for controlled environments or in scenarios where precise landing is crucial, such as in drone delivery services, military operations, or when operating in sensitive or congested areas. The designation of a DLS is important for ensuring safety, efficiency, and compliance with regulatory guidelines for drone operations.

The direction of a vehicle is a parameter typically calculated during approach and landing; for example, when the vehicle and landing site include a charging station, a battery replacement station, or any other equipment that requires the vehicle to land in a certain direction. But the direction of the vehicle need not be one of the parameters calculated during the approach and landing procedure. For example, most quadcopters can land facing any direction. Sounds emitted by different propulsion mechanisms of a vehicle can be similar such as engines and rotors of a quadcopter or different such as the main rotor and tail rotor of a helicopter. In the case of a vehicle with one sound source or with multiple sources with similar sound signatures, additional equipment may be needed to determine the direction of the vehicle.

The disclosed sound-based navigation techniques work with automatically navigated unmanned, remotely controlled, as well as manned vehicles to assist the pilot with approach and landing procedures.

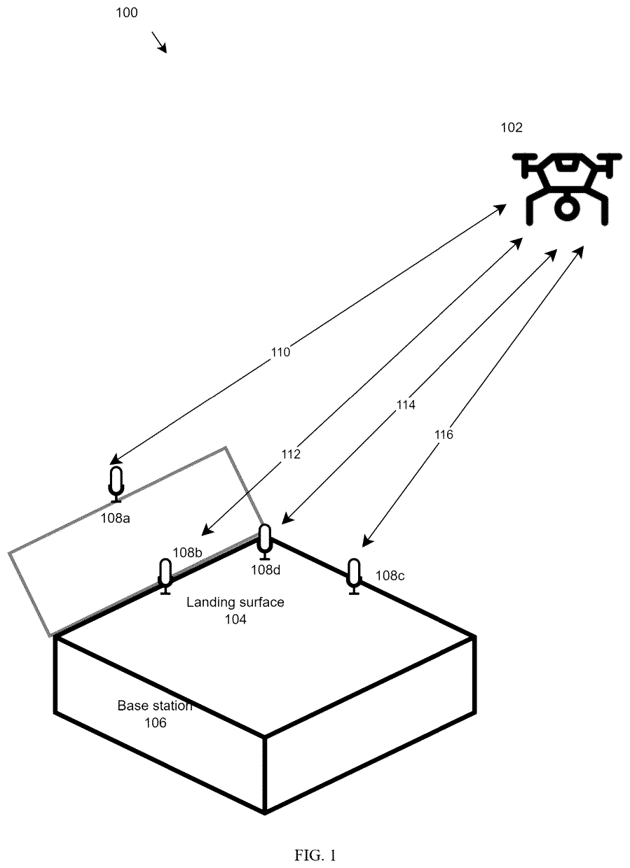

FIG. 1 shows a basic four-microphone configuration 100 where drone 102 is approaching landing surface 104 of base station 106. In this configuration, four microphones 108a, 108b, 108c, and 108d are positioned on landing surface 104. Four microphones 108a-d are configured for recording sounds emitted by drone 102. The distance traveled by the sound waves from drone 102 to each of microphones 108a-108d is shown by distances 110, 112, 114, and 116. The position of drone 102 can be calculated using the difference between two distances, the quotient of two distances, or by the distance itself. Position calculation methods are described in greater detail below.

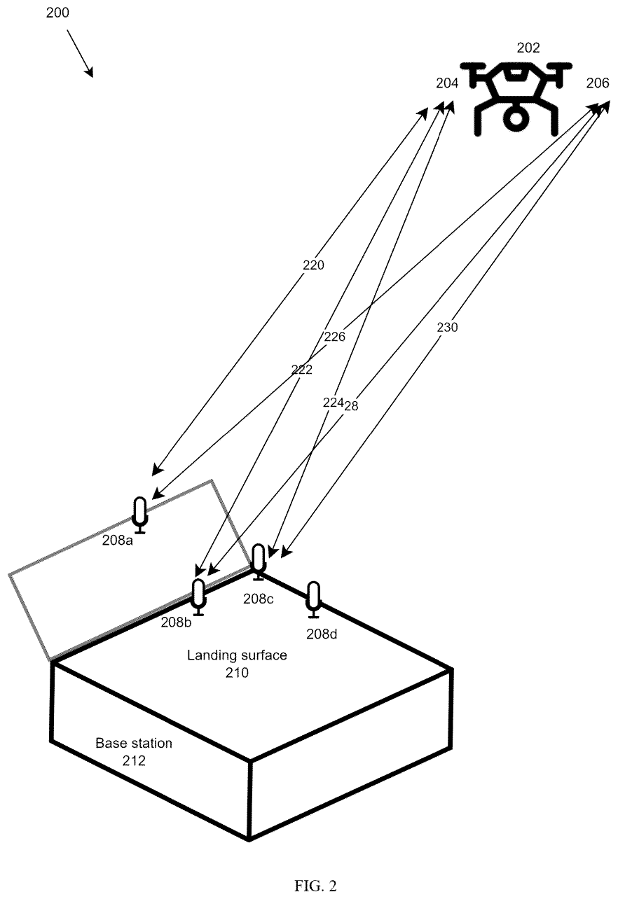

FIG. 2 shows an alternative basic configuration 200. Here, drone 202 has rotors 204 and 206 that each emit sounds that can be detected by microphones 208a, 208b, and 208c. Microphone 208d also detects sounds from rotors 204 and 206 but this is not shown in FIG. 2 to simplify the drawing. The microphones are mounted on landing surface 210, which is an upper surface of base station 212. The distance traveled by sounds emitted by each of rotor 204 and 206 are shown as distances 220, 222, and 224 for rotor 204 and distances 226, 228, and 230 for rotor 206. In the configuration of FIG. 2, drone 202 has two distinct sound sources, rotor 204 and rotor 206. The processing of distinct sounds emitted from different sources onboard done 202 can be used for calculating the location of drone 202.

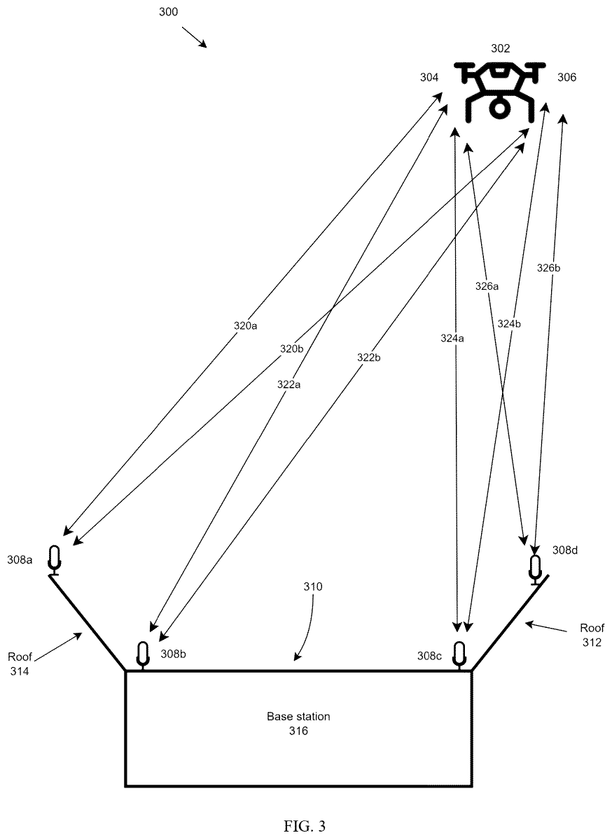

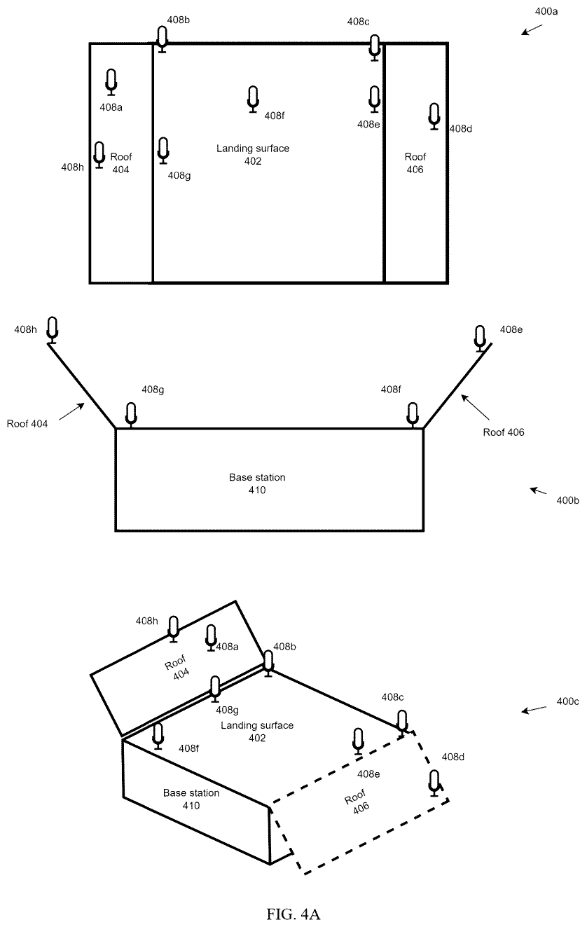

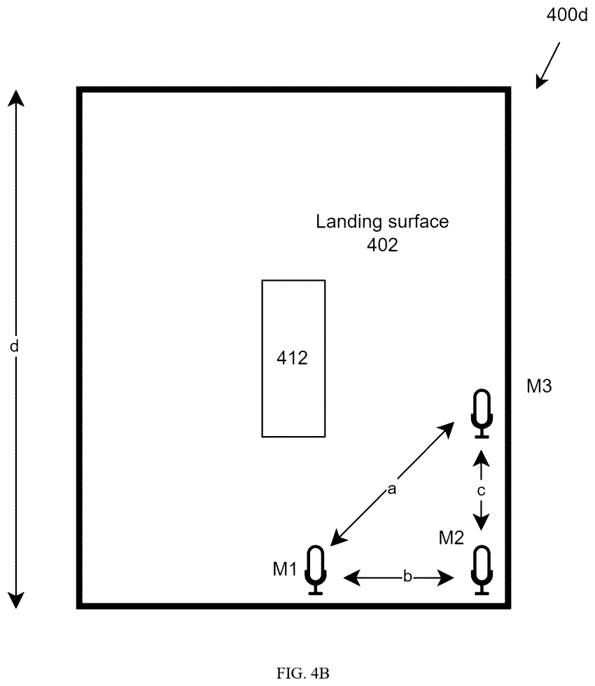

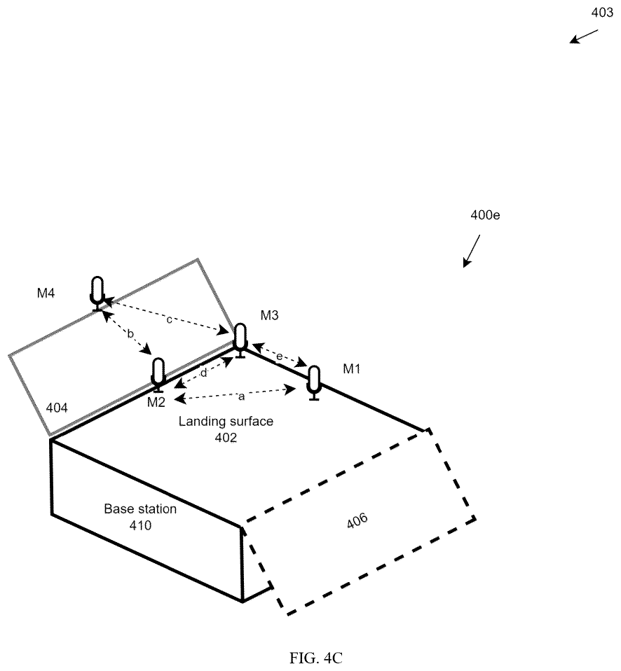

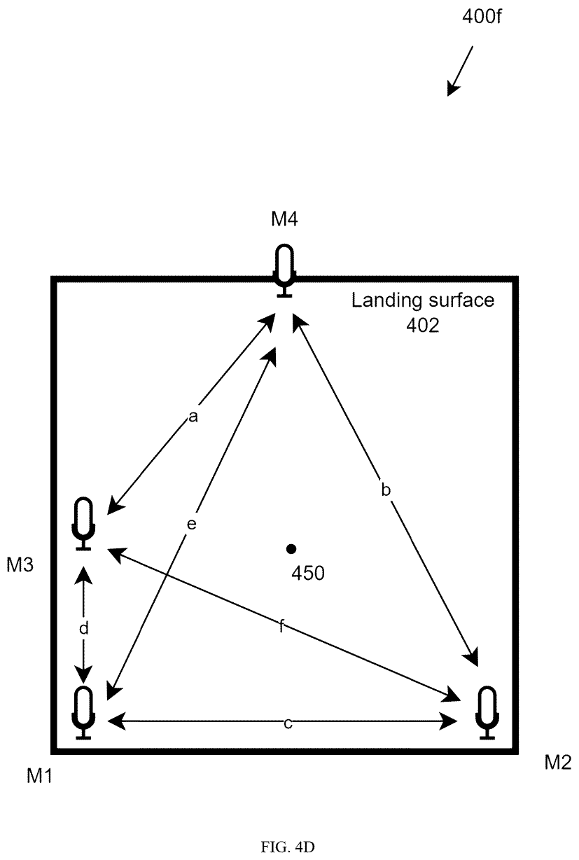

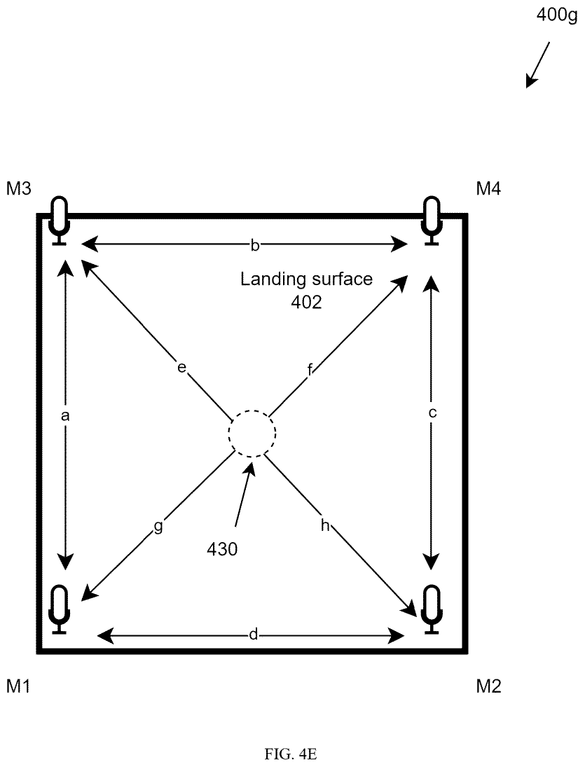

FIG. 3 shows a more advanced configuration 300 with eight microphones arranged in tiers. Sounds emitted by drone 302 from rotors 304, 306 are recorded by microphones 308a, 308b, 308c, and 308d. Sound signals from rotors 304, 306 are received by the microphones, as represented by signals 320a, 320b (microphone 308a), signals 322a, 322b (microphone 308b), signals 324a, 324b (microphone 308c), and signals 326a, 326b (microphone 308d). Microphones 308a-d are mounted in two tiers. Microphones 308b, 308c are mounted on landing surface 310 of base station 316. Microphones 308a, 308d are mounted on roofs extending from base station 316. In FIG. 3, only the side view is shown. The microphone configuration of FIG. 3 is shown in more detail in FIGS. 4a, 4b, and 4c.

FIG. 4A shows further details of exemplary eight-microphone configurations. Top view 400a of an eight-microphone configuration comprises landing surface 402 with two angled roofs 404 and 406. Eight microphones 408a-h are positioned on landing surface 402 and roofs 404, 406 as shown. Side view 400b shows this configuration with emphasis on how angled roofs 404 and 406 extend from base station 410. Side view 400b does not show microphones 408a, 408b, 408c, and 408d. But microphones 408a-d are in fact positioned in relation to the landing surface 402 as shown elsewhere in FIG. 4A. Perspective view 400c shows all eight microphones 408a-h from top view 400a. In perspective view 400c, roof 406 is adjusted from its usual angle only to show the placement of microphones 408d and 408e. In operation, roof 406 is angled to approximately match the angle of roof 404, as shown in side view 400b.

Base station 410 is equipped with a microphone array comprising eight microphones with synchronous Analog-to-Digital Converts (ADCs) mounted in two tiers on the drone station. The first tier is mounted at landing-surface level. The second tier is near the top of an open roof of the base station with an elevation of about 20-50 centimeters. In some aspects, the second tier is at an elevation less than about 20 centimeters. In some aspects, the second tier is at an elevation of greater than 50 centimeters. In an exemplary pair configuration, the distance between two microphones is between about 0.5 meters and 1 meter. In some aspects, the distance between two microphones is less than 0.5 meters. In some aspects, the distance between two microphones is greater than 1 meter.

The synchronous ADCs mounted on the base station in this embodiment comprise an audio capture environment. The eight microphones are arranged in an array for sound localization and beamforming (focusing on a specific sound source while minimizing others). Each microphone in the array is connected to an ADC such that all eight ADCs are synchronized with each other. This synchronization allows phase and timing differences between audio signals captured by different microphones to be used to determine the direction and distance of the sound source. Synchronous ADCs ensure that the digital audio data from all microphones is aligned in time, which allows for more accurate processing and analysis.

Digital signals from the microphones are sent to a computing device (not shown in FIG. 4A), which extracts spatial information from the signals. The computing device transforms signals to a complex spectral domain where the phase difference between signals corresponds to the delay between the signals in the time domain.

FIG. 4B shows an alternative embodiment 400d of landing surface 402 from FIG. 4A with a three-microphone configuration. Microphones M1, M2, and M3 are positioned on landing surface 402 in a planar configuration. The distances between microphones M1, M2, and M3 are represented by lines a, b, and c. The length of the landing surface is represented by line d. A battery charging shaft 412 is positioned on landing surface 402. The three microphones comprise three possible pair relationships. Microphones M1 and M2 can be paired at distance b, microphones M2 and M3 can be paired at distance c, and microphones M1 and M3 can be paired at distance a. In an exemplary embodiment, distance d is about 1.5 meters and the distance between microphones M2 and M3 is about 0.5 meters. The midpoint of line a coincides with the axis of uncertainty, which will be explained in detail below. This configuration is able to capture sounds around 800 Hz and will be effective in detecting sounds in the range of 300 Hz to 600 Hz, which are the usual range for drone motors.

FIG. 4C shows an exemplary configuration 400e with four microphones M1, M2, M3, and M4. Microphones M1, M2, M3, and M4 are in a non-planar configuration because microphone M4 is positioned on roof 404, which is elevated with respect to landing surface 402. The distances between microphones M1, M2, M3, and M4 are shown by distance a (M1-M2), distance b (M2-M4), distance c (M3-M4), distance d (M2-M3), and distance e (M1-M3). In this configuration, an axis of uncertainty for microphones M1, M2, and M3 coincides with the midpoint of distance a, which is perpendicular to landing surface 402. Another axis of uncertainty for microphones M2, M3, and M4 coincides with the midpoint of distance c. This axis is perpendicular to the open roof surface 404. The two axes of uncertainty intersect at one point, which allows the uncertainty to be removed. In an embodiment, the M4 position can be adjusted to make the two axes of uncertainty non-intersecting.

FIG. 4D shows an exemplary configuration 400f with four microphones M1, M2, M3, and M4 on landing surface 402. The distances between microphones are represented by lines a, b, c, d, e, and f. In this configuration, the microphone combinations (M1, M3, M4) and (M1, M4, M2) and (M1, M2, M3) and (M2, M3, M4) each have their axis of uncertainty in different places. For example, the combination (M1, M2, M3) has an axis of uncertainty at the midpoint of line f. The combination (M1, M2, M4) has an axis of uncertainty at point 450, which is the intersection of lines from the midpoints of distances e, b, and c. This configuration can be compared with the configuration of FIG. 4E, where the axis of uncertainty for each combination is at the center of landing surface 402.

FIG. 4E shows configuration 400g with a sub-optimal configuration of microphones M1, M2, M3, and M4 on landing surface 402. The distances between microphones are shown by lines a, b, c, and d. The distances that cross center point 430 are divided into sections e, h for the distance between M3 and M2 and into sections g, f for the distance between M1 and M4. In this configuration, each combination of microphones has an axis of uncertainty at center point 430. For example, the axis of uncertainty for combination (M1, M2, M3) is at the midpoint of distance e, h. The axis of uncertainty for combination (M1, M2, M4) is at the midpoint of distance g, f. And the axis of uncertainty for combination (M1, M3, M4) is also at the midpoint of distance g, f. All three of the points are located at center point 430. The consequences of such positioning will be explained in detail below.

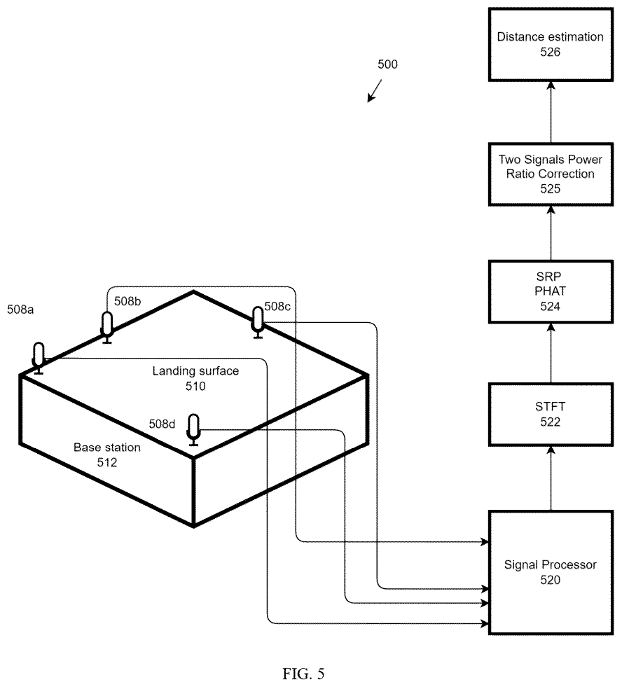

Signal processing is shown in FIG. 5, which shows process 500 for processing sound data collected by microphones 508a-d positioned on landing surface 510 of base station 512. The microphone configuration in FIG. 4A comprises four microphones to simplify the drawing. Other microphone configurations can also be used, such as the eight-microphone configurations of FIG. 4A. Exemplary microphone configurations comprise 3 microphones, 4 microphones, and more than 4 microphones in various configurations.

Steered Response Power (SRP) is a technique used in sound source localization, which involves steering a beamformer to different points in space and calculating the power of the received signal at each point. For every potential sound source location, the time delays between this point and each microphone in the array are calculated, corresponding to the time it would take for sound to travel from that point to each microphone. The Phase Transform (PHAT) is employed to improve the robustness of the SRP method, especially in environments with reverberation or noise. PHAT normalizes the cross-correlation functions between signals from different microphones, focusing on phase information over amplitude, which helps reduce the influence of signal strength variations due to distance or environmental factors. The Generalized Steered Response Power (GSS) extends the basic SRP approach, combining outputs of multiple beamformers steered to different points in space. GSS enhances the ability to localize sound sources accurately in complex acoustic environments.

Each microphone captures sounds that are digitized. For each potential source location in 3D space, the expected time delays for sound reaching each microphone are calculated. Cross-correlation between signals from different microphones is computed with PHAT weighting to emphasize phase information. Beamforming is then applied, steering to each candidate point in space and computing the power of the summed signal. This calculated power at each point gives an estimate of the likelihood that the sound originated from that point, with the highest power indicating the most likely source location. Repeating this process for numerous points creates a map of potential sound source locations in 3D space.

In the embodiments shown in FIG. 1-5, the ADC is integrated directly into the microphone itself to enhance efficiency and precision. Distinct ADC units may also be used.

Digitized signals from microphones 508a-d are received at signal processor 520. Signal processor 520 passes the collected signals for processing by STFT Module 522 and SRP PHAT module 524. Embodiments can include (though not depicted in FIG. 5) at least one processor and operably coupled memory including instructions that, when executed, cause the at least one processor to implement signal processor 520, STFT module 522, SRP PHAT module 524, distance-ratio calculation module, and distance estimation module 526.

STFT Module 522 applies a Short-Time Fourier Transform, a mathematical technique used to analyze the frequency content of signals that change over time. A longer time signal is divided into shorter segments of equal length and then the Fourier Transform is computed separately on each of these segments. This approach provides a two-dimensional representation of the signal, showing how its frequency content evolves over time. STFT can be used for analyzing the sounds captured by a drone's microphone array for sound source localization, or processing the signals from the drone's sensors to understand environmental characteristics. STFT is particularly useful in scenarios where the frequency characteristics of the signal are not stationary and change over time.

Module 524 applies techniques such as GCC SRP PHAT for estimating the likelihood of a drone's location based on features that are like Time Difference of Arrival (TDOA). Then grid points are found with top score values. Signal power criteria can be used to increase accuracy in picking the best point from among the top scores. The GCC SRP-PHAT method for sound source localization in drone arrays integrates spatial and signal processing concepts. The process involves calculating the steered response power at various spatial points by summing microphone signals adjusted for time delays. These time delays, denoted as Δt, are calculated based on the speed of sound and the distances between each hypothetical sound source location and the microphones.

In the GCC SRP-PHAT method for sound source localization, the grid refers to a virtual, spatial construct defined around the target area for identifying the location of the sound source. The grid divides the area into a matrix of points or nodes, each representing a potential sound source location. The resolution of this grid, indicating the proximity of these points to each other, can be changed based on the required precision. During the localization process, the GCC SRP-PHAT algorithm evaluates the signals from the microphone array for each grid point, calculating the steered response power. This steered response power calculation assesses how the sound signals align if they were emanating from each specific grid point. The point on the grid with the highest response power is then identified as the most probable origin of the sound, thereby allowing the algorithm to systematically analyze and pinpoint the sound source location within the physical space using the data from the microphone array.

SRP-PHAT calculates the steered response power (SRP) value for all positions in the search space. Then the maximum SRP value is used to localize the sound source. SRP-PHAT is a short-time analysis and short signal, a frame of a sound signal, for example, can be used to calculate the SRP value.

The SRP value, the sum of the generalized cross-correlation phase transform (GCC-PHAT) function with the signals collected by all microphone pairs can be expressed as Equation 1:

$${\hat{P}}_{i} ( q ) = {\sum }_{m = 1}^{M} {\sum }_{n = m + 1}^{M} {\hat{R}}_{mn}^{( i )} [ {τ}_{m , n} ( q ) ] \qquad ( Equation 1 )$$

In this equation, [symbol] (q) represents the SRP value at a possible location q calculated using the i-th frame of the signal. \hat{R}

$${( i )}_{mn}$$

[τ_{m,n}(q)] represents the GCC-PHAT function of the i-th frame of the signals collected by the m-th and n-th microphones. The GCC-PHAT function can be written as Equation 2:

$${\hat{R}}_{mn}^{( i )} = \frac{1}{L} {\sum }_{k = 0}^{L - 1} \frac{{X}_{m , i} ( l ) {X}_{n , i}^{*} ( k )}{\vert {X}_{m , i} ( l ) {X}_{n , i}^{*} ( k ) \vert} {e}^{j ωτ} \qquad ( Equation 2 )$$

where, X_{m,i}(k) is the discrete Fourier transform (DFT) of x_{m,i}(l) and x_{m,i}(l) is the i-th frame of the signal collected by the m-th microphone. The symbol “*” means conjugate and L is the number of DFT points. The symbol ω is the analog angular frequency, while τ is the abbreviation of τ_{m,n}(q), which represents the TDOA from the imaginary sound source to the m-th and n-th microphones. This function normalizes the cross-spectral density of the signals, reducing the influence of varying signal amplitudes and highlighting the phase differences crucial for precise localization. In application, this calculation is iterated over the entire grid, with the point exhibiting the highest SRP value identified as the most likely sound source location. This method combines the mathematical rigor of Fourier transforms and cross-spectral density normalization with spatial analysis. GCC SRP-PHAT thereby accurately discerns sound sources amidst ambient noise and reverberation.

The variables rₘ and rₙ represent the rectangular coordinate vector of the m-th and the n-th microphones. If c refers to the speed of sound in the air (about 340 m/s), the expression of τ_{m,n}(q) is Equation 3:

$${τ}_{m , n} ( q ) = \frac{( ‖ q - {r}_{m} ‖ - ‖ q - {r}_{n} ‖ )}{c} \qquad ( Equation 3 )$$

After calculating the SRP for each possible location, the location with the largest SRP is designated as the location estimate as Equation 4:

$$\hat{q} = {arg max}_{q} {\hat{P}}_{i} ( q ) . \qquad ( Equation 4 )$$

Due to the effect of noise and reverberation, the location estimate obtained by different frames of a sound signal can vary.

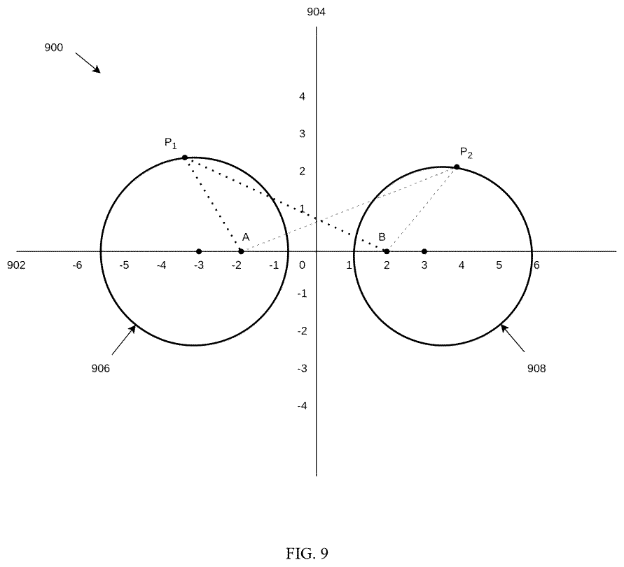

In an embodiment, three microphones are used for collecting sound signals and a distance-ratio calculation can be performed by module 525 as discussed in connection with FIG. 9 below. Module 526 can optionally perform a distance estimation by re-calculating the absolute signal power to distance to sound source, assuming the original sound power is known. Optionally, the scores of modules 524, 525, and 526 can be combined into a common score to find the point with the maximal score value.

The computing device performs an estimation on all points of the grid and defines the most probable drone 3D position. The position is then sent to the drone for use in effecting maneuvers. In an embodiment, the computing device must be preloaded with data showing a geometric map of the microphone installation.

In an embodiment, the microphone array is used not for drone detection or maneuver classification. The microphone array is used only for determining drone coordinates. The coordinates are then used for drone landing or takeoff procedures. This allows the system to be entirely passive, where the drone is not required to carry any additional hardware or equipment.

A variety of methods for assisted vehicle navigation can be implemented using the system components described in connection with FIGS. 1-5. In a basic embodiment, microphones, a base station, and a preprogrammed computing device are used for vehicle (drone) navigation. The vehicle emits sound as it approaches a designated landing site (DLS). The vehicle is traveling in a 3-dimensional space capable of conducting sound waves. Microphones have been installed at or near the DLS. In an embodiment, the microphones can be positioned to avoid the same 2-dimensional plane. In other embodiments, a non-circumfered quadrilateral in the same plane can be used. Signals from the microphone are passed to a computing device comprising a signal processor. Analog signals captured by the microphones are converted to digital signals for processing. The processing operation comprises a relative-location calculation based on the output of the microphones, the recorded sounds emitted by the vehicle. From the digital signals a location is calculated for the vehicle. The location is sent to the vehicle for use in navigation. A command to act on the location data can also be communicated to the vehicle.

The microphones are in communication with the signal processor. This communication can be wireless or through a direct connection. The microphones and signal processor also have a logical connection. In this context, a logical connection refers to the relationship and interaction between components within the system that enables them to work together to perform a specific function or task. These components can be hardware or software elements, and the logical connection defines how data, signals, or instructions flow between them to achieve a desired outcome. One fundamental aspect of logical connections is data flow. These connections define how data moves between different components in the system. Logical connections also encompass communication protocols. These protocols define the rules and mechanisms for data exchange between devices. They specify the format, timing, and error-checking procedures for data transmission, ensuring reliable communication. Furthermore, logical connections can include interface specifications that facilitate communication between components with different designs or functionalities. These interfaces ensure compatibility between various hardware and software elements, allowing them to work together seamlessly. Security protocols can be used for protecting the integrity and confidentiality of data. These protocols can involve encryption, authentication, and access control mechanisms to safeguard information from unauthorized access.

The base station further comprises a computing device used for determining the 3-dimensional position and speed of the source of sound associated with the vehicle relative to the designated landing site. The computing device includes a signal processor and modules for calculating the vehicle's position. This allows for obtaining the location, direction, and speed of the vehicle in relation to the designated direction of the designated landing site DLS. The computing device can also be configured for issuing commands to decrease the distance between the vehicle and the designated landing site, including instructions about the angle between the direction of the vehicle and the direction of the landing site. A communication module connected to the base station is used for communicating the vehicle's identified location to the vehicle. The vehicle, after receiving its location information, executes maneuvers accordingly. Alternatively, the vehicle can execute maneuvers in response to specific commands sent from the base station.

The direction of the vehicle is also calculated by the computer logically connected to the base station module and microphone array. The direction of the vehicle is determined by the base station issuing a command to the vehicle to move at a direction relative to the designated direction of the vehicle, for example, forward, backwards, left, or right. The changes in the digitized output of the microphones are analyzed after the vehicle has completed the command.

In an embodiment, an additional source of sound on the vehicle such as a buzzer with a sound signature distinct from the main source of sound is used. For example, the main source of sound is an engine. The direction of the vehicle is determined by analyzing the relative position of the engine and the additional source of sound.

In an embodiment, the vehicle is equipped with three or more similar sources of sound. Engines are positioned so that determining their relative position allows the determination of the direction of the vehicle. For example, the vehicle can be configured with a plurality of rotors and the direction of the vehicle will be determined based on the location of these distinct sources of sound located on the vehicle.

In another embodiment, the three or more microphones are configured in two or more pairs of microphones. Each pair of microphones coordinates their output, such as averaging calculations and removing outliers.

Transmission of information and commands to the vehicle can be accomplished by a variety of conveyances, including radio, light, or sound signals.

The vehicle can change the controlled parameters of one or more of its propulsion systems for transmitting a distinct sound signal to the microphones at the base station.

The vehicle itself can also be identified by its specific sound signature. The specific sound signature allows a specific vehicle to be identified by the base station. Without a distinctive sound signature, one drone may be indistinguishable from another based on sounds captured by the microphone array. For added security, the vehicle can have a public key encryption key stored at the base station for authenticating the identity of the vehicle.

Vehicle commands can be created by the computer using a neural network previously trained on vehicle navigation data. Neural network training for drone navigation begins with data collection. This involves gathering a comprehensive dataset from various drone flight scenarios, including drone positional data (like GPS coordinates, altitude), environmental factors, and the corresponding directional commands that have been used for successful navigation. Once collected, the data is preprocessed. This includes cleaning the data to remove errors or irrelevant information, normalizing the cleaned data to a consistent scale, and extracting relevant features that are predictive of the correct directional commands.

The next step is configuring the neural network. The neural network architecture is suitable for processing sequential data, such as Recurrent Neural Networks (RNNs) or Long Short-Term Memory (LSTM) networks. The input layer of the network corresponds to the positional and environmental data of the drone, while the output layer maps to the directional commands.

Training the neural network involves dividing the dataset into training, validation, and test sets. The training data is fed into the network, allowing the network to learn the correlation between the drone's position, environmental factors, and the corresponding directional commands. An optimization algorithm is used to adjust the weights in the network, minimizing the error in predictions. The validation set helps in tuning hyperparameters and avoiding overfitting.

After training, the network is tested and validated using the test dataset to evaluate its performance in giving accurate directional commands. Appropriate metrics like accuracy, precision, and recall are used to assess the model's effectiveness.

Finally, the trained model is implemented in a real-world drone to test its navigation capabilities. A feedback mechanism is established to continuously collect data on the drone's navigational decisions and outcomes, which can be used for further training and refining the model, enhancing its accuracy and reliability over time.

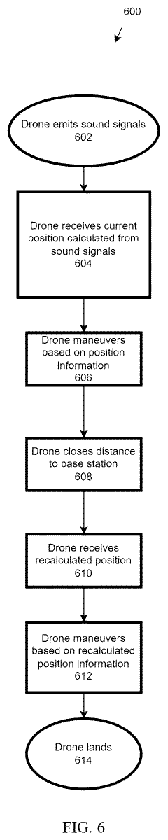

An exemplary implementation method 600 is shown in FIG. 6. The method of FIG. 6 focuses on implementation of maneuvers of a drone using location data received from a base station equipped with a microphone array.

At 602, a drone emits sound signals that are captured by a plurality of microphones positioned at or proximate a base station. At the base station, a computing device logically connected to the microphones processes the sound signals and calculates the drone's position in 3D-space. The calculations can be made substantially as described in connection with FIG. 5 above. The calculated position is then ready to send to the drone. Alternatively, a command to take certain maneuvers can be sent to the drone, either alone or in combination with location data.

At 604, the drone receives its calculated position from a transmitter in logical connection with the computing device. The drone also receives commands from the base station if any have been sent. At 606, the drone uses the calculated position to effect maneuvers that change its direction or speed. The drone can also carry out commands from the base station. At 608, the drone moves closer to the base station. When the drone's destination is the base station, the base station can be considered a designated landing site for the drone.

At 610, the drone receives a recalculated position from the transmitter at the base station. This recalculated position will have been generated by the base station substantially as before. The base station will have additional data for the recalculation based on changes in the drone's trajectory, which will be accounted for by the signal processing unit at the base station.

At 612, the drone affects a second set of maneuvers based on the recalculated position. 612 is repeated, bringing the drone closer to the base station. 610-612 are repeated until the drone is at the landing point. At 614, the drone completes the series of maneuvers and lands at the landing site.

In an embodiment, the drone switches off its propulsion system of the vehicle once the approach and landing procedure has been completed.

The disclosed systems and methods implementing the invention improve drone flight operations by maximizing the use of ground-based compute, power, and hardware. Drone payload and power resources are limited compared to the base station. Thus, the base station primarily handles signal collection and extraction of coordinates from sound data. In comparison to the base station, the drone plays a relatively passive role in navigation.

In alternative embodiments, the landing surface can be at known coordinates outside the base station. In these embodiments, the base station can be in close proximity such that its microphone array can collect signals for calculating the drone's position.

In the embodiments described, at least three microphones are used. In some embodiments, four or more microphones are used. Some four-microphone arrays are shown in the Figures where the microphones are in the same plane. This is shown for simplicity only. In use, microphone arrays should preferably not be positioned in one plane, especially not on prohibited geometric figures such as squares and the like. For example, two pairs of microphones can locate coordinates (X,Y) but this leaves uncertainty in the Z dimension. A microphone in another plane can solve the Z uncertainty. So for localizing (X, Y, Z) three microphones are positioned in one plane and at least one microphone is positioned in another plane.

The use of eight or more microphones in pairs improves the quality of the signal data. Each microphone pair generates improved results because the spatial results of each pair of microphones can be averaged or statistically processed to eliminate outliers.

Although implementations with airborne vehicles have been described, other embodiments are possible, such as underwater vehicles or vehicles in other environments where sound-based navigation can be implemented.

In an embodiment, a method using Time Difference of Arrival (TDOA) is applied to sound signals. For the sound signals a Time Difference Of Arrival is extracted from two signals received by a pair of two microphones.

The difference in the time of arrivals of specific sound signatures is measured by 2 microphones. A specific signal is filtered and other sound mixtures (in temporal or spectral domain) are suppressed. A time shift is sought for one filtered signal that leads to a perfect fit with other filtered signals. The method is carried out in the temporal domain by direct shifting and comparison (like convolution and correlation calculates). Alternatively a spectral domain is used after STFT by comparison of the best phase rotation that leads to a perfect spectrum match.

A time of arrival which is more than one period of periodic signal is not measured, so the distance between microphones should be not more than PERIOD*SPEED_OF_SOUND. For 1 kHz sound this distance is 0.34 m. For 250 Hz the distance is 1.36 m and for 25 Hz the distance is 13 meters.

Electric motors have a base harmonic of about 180 Hz while blades have a base harmonic of about 360 Hz. In an embodiment, operating frequencies are between about 300 Hz to 500 Hz. Under these conditions, the calculated spacing distance between microphones is 0.5-1.5 meters. The size of most drone landing sites is consistent with such spacing distances.

TDOA positioning is a passive technique to localize and track emitting objects by exploiting the difference of signal arrival times at multiple, spatially-separated receivers. Given a signal emission time (te) from the object and the propagation speed (c) in the medium, the time-of-arrival (TOA) of the signal at 2 receivers located at ranges r₁ and r₂ respectively from the object can be denoted as Equation 5:

$$\begin{matrix}{t}_{1} = {t}_{c} + \frac{{r}_{1}}{c} \\ {t}_{2} = {t}_{c} + \frac{{r}_{2}}{c}\end{matrix} \qquad ( Equation 5 )$$

With 1 pair of microphones, it can be known that the drone is on a certain hyperboloid, which is a surface in 3D space. One pair of microphones produces a hyperboloid surface. Each point of this surface can be a sound source location. After adding a 2nd pair of microphones, a new hyperboloid surface is generated that intersects the first hyperboloid at 2 curved lines in 3D space. Each point on these lines can be a sound source location. A 3rd microphone pair and 3rd hyperboloid intersect only one of two curved lines in two points. One point is located above the three microphone planes and the second point below this plane. For drone landing, it is known a priori that the vehicle is above the ground, so we pick up this single point as the vehicle's location. Thus, a 2D case can be solved with 3 microphone pairs.

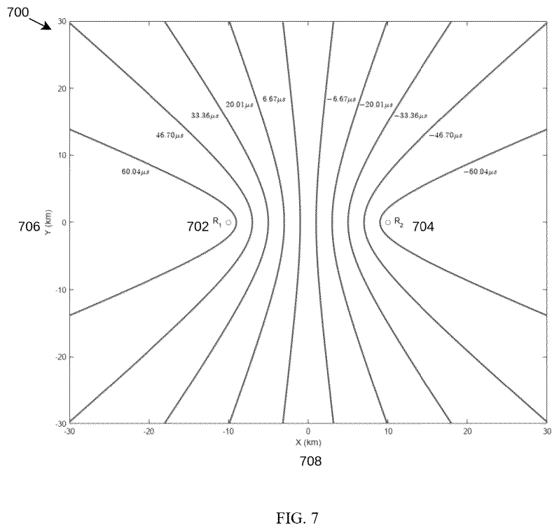

As an example of these principles, FIG. 7 shows a two-dimensional projection 700 of three-dimensional half-hyperboloids (in space) or half-parabolas (on plane) to illustrate SRP PHAT based on Time Difference of Arrival (TDOA). In this example, two receivers 702 (R₁) and 704 (R₂) are positioned with reference to Y-axis 706 and X-axis 708. These two receivers 702 and 704 illustrate an exemplary embodiment of the two receivers located at ranges r₁ and r₂ as described above with reference to Equation 5.

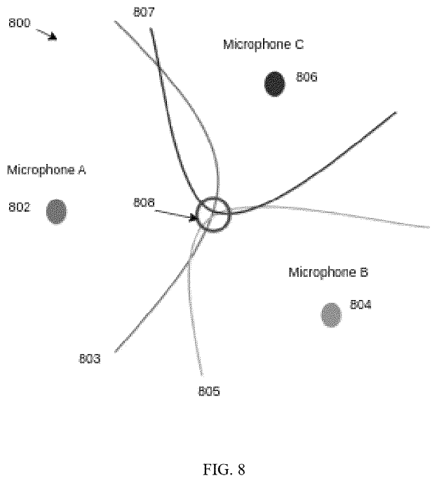

FIG. 8 is an illustration of hyperbola intersections 800 in two dimensions. Three microphones A (802), B (804), and C (806) are shown. Each hyperbola is based on TDOA, which is the time difference between two microphones. Each hyperbola also corresponds to a pair of microphones. Hyperbola 803 corresponds with microphone pair AC, hyperbola 805 corresponds with microphone pair AB, and hyperbola 807 corresponds with microphone pair BC. The three hyperbolas intersect at point 808.

One pair of microphones creates a 3D single hyperbolic sheet (half-hyperboloid) surface. Two pairs of microphones produce two intersecting hyperbolic sheets, the intersection of which is a single curved line in a 3D space. The third pair of microphones produces an intersection of this line with a new hyperbolic sheet where a proper arrangement of the microphones in either a single point or two distinct points. Thus, in 3D space using three microphones two 3D points can be calculated. One of the four points is the real drone position. The other three points are phantoms. In certain conditions there can be two points or even only one point.

In the case where only three microphones form three pairs, the additional point is a phantom point symmetrically located on the opposite side of the plane formed by the three microphones. This is because the distance differences for such a point will be the same for all pairs of microphones. In the case of airborne vehicles and with microphones positioned horizontally, this phantom point is located below the ground. Therefore, it can be eliminated, allowing the single detected point above the ground to be identified as the airborne vehicle's coordinates.

The sound signals that give rise to TDOA are generally noisy, so an increased number of pairs will be used for better accuracy.

With N(N≥2) receivers, a total of

$$N ( \frac{N - 1}{2} )$$

TDOA measurements from an object can be obtained by calculating the time difference of arrival using each combination of the receiver. Of these measurements, only N−1 measurements are independent and the rest of the TDOA measurements can be formulated as a linear combination of these independent measurements. So, if four radio receivers are used, only three pairs of TDOA direct measurements will be independent out of the six possible measurements. For the sound sources, in an embodiment each signal pair is calculated separately. Thus, there will be six acoustically estimated TDOA from six pairs. In some embodiments, four or more microphones are used. In these embodiments, four microphones in the same plane are effective for 3D localization.

In an embodiment, three microphones are used for sound localization. Each microphone signal is filtered to extract a specific sound signature. TDOA can be measured between signals of microphone A and microphone B and thereby calculate a corresponding half-hyperboloid with radial symmetry around an axis connecting these 2 microphones. The sound source will lie on this half-hyperboloid. This measuring method, which will be referred to as “operation (1)” ensures a high level of robustness and accuracy. Operation 1 is substantially similar to SPR-PHAT.

In an alternative embodiment, the calculation facilitated by the illustration 900 shown in FIG. 9 is used for sound localization. The power of an acoustic signal decreases in inverse proportion to the square of the distance from the sound source. The level of the signal A and signal B can be measured and the ratio

$$\frac{signal ( A )}{signal ( B )}$$

calculated accordingly. This graph is illustrated in FIG. 9, where microphones A and B and points P1 and P2 are positioned with respect to x-axis 902 and y-axis 904. In FIG. 9, the calculation corresponds to the locus of points P having constant ratio of distances to microphones A and B. The locus of a calculation in this form (A,P₁/B,P₂) can be described by two spheres 906 and 908 with centers lying on the line described by x-axis 902 connecting the microphones.

In an embodiment, measuring the ratio of the amplitude for the acoustic signal reveals that the sound source is lying on one of these two spheres 906, 908. This method, which will be referred to as “operation (2)” has medium robustness and accuracy because it is vulnerable to external noises that cannot be filtered.

Given a sound source with a constant and calibrated level, the distance to the sound source can be calculated directly. By measuring the sound level it can be determined that the sound source lies on a sphere with a center at a microphone's position and where the radius is the distance to the sound source. This method, which will be referred to as “operation (3)” has some robustness and accuracy, but is limited by the assumption that the sound source is perfectly calibrated.

Certain techniques for localizing the sound source have specific vulnerabilities. For example, when distances from the sound source to both microphones are equal to each other there are two conditions presented. First, TDOA equals zero, which leads the hyperboloid to degenerate into a plane perpendicular to the line connecting two microphones and intersecting it in the center. Second,

$$\frac{signal ( A )}{signal ( B )} = 1$$

and instead of two spheres the locus of the solution will degenerate to the same plane perpendicular to the line connecting the two microphones.

In an embodiment, three microphones A, B, and C are used for sound localization. The following steps exemplify the method:
1. Operation (1) is applied to A and B to find the half-hyperboloid HypAB.
2. Operation (2) is applied to A and B to find two spheres SphereAB.
3. The intersection of HypAB and SphereAB is determined and will be circle CircleAB in the plane perpendicular line AB.
4. Operation (1) is applied to A and C to find half-hyperboloid HypAC.
5. Operation (2) is applied to A and C to find two spheres SphereAC.
6. The intersection of HypAC and SphereAC is found and will be the circle CircleAC in the plane perpendicular to line AC.
7. The intersection of CircleAB and CircleAC can also be found and will be the two points PointTop and PointBottom such that PointTop lies on the one side of plane ABC and PointBottom on the other side of plane ABC.
8. If ABC is located on the landing surface, the solution will be PointTop.
9. Optionally, CircleBC can be calculated and used to increase the precision of the PointTop coordinates.

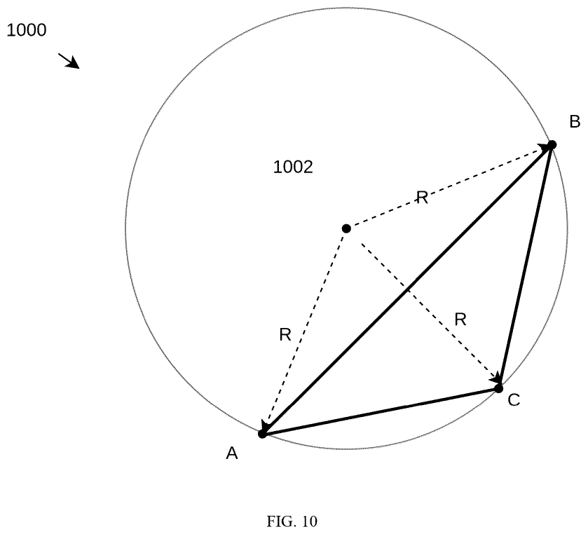

A special case is presented where the sound source is equidistant from all points A, B, and C. This special case 1000 is shown in FIG. 10. Such a point exists always and it is the center of a circle 1002 of radius R circumscribing a triangle ABC and all the points of the line perpendicular to plane ABC and intersecting it in this center. This point can be described as an axis of uncertainty. Steps 1-3 result not in CircleAB but the plane perpendicular to AB. Steps 4-6 give not CircleAC but the plane perpendicular to AC. Accordingly, step 7 does not produce two points but gives the line containing all equidistant points. Thus, the altitude of the sound source above plane ABC remains unknown.

A configuration of three microphones positioned on the same line is not used. This configuration prevents CircleAB, CircleAC and CircleBC from being the same circle and obscuring PointTop and PointBottom.

In an embodiment, configurations with four microphones do not locate the microphones in the same plane quadrilateral allowing circumscribing (square, rectangle, isosceles trapezoid and family of “unnamed” quadrilaterals). This configuration is avoided so that step 9 above can be avoided and generally to increase robustness.

In an embodiment, a rhombus shape is used for positioning microphones to avoid being circumscribed. Thus, there will be no point equidistant from the microphones. Optionally, three microphones are chosen and steps 1-7 can be performed effectively. In another embodiment, four microphones are used and configured so they are not in the same plane. In this case, only one final point will be found so we do not need to drop PointBottom by virtue of its being “below” the landing surface.

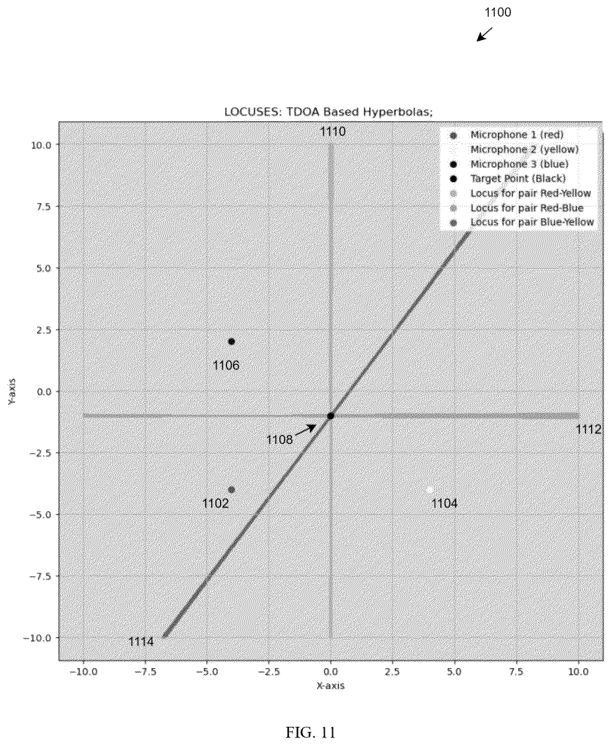

FIG. 11 shows a situation where sound source point is equidistant from 3 microphones 1102 (“red”), 1104 (“yellow”), and 1106 (“blue”). The source point is represented by target point 1108, which lies at the intersection of locus for pair red-yellow 1110, locus for pair red-blue 1112, and locus for pair blue-yellow (1114). This means that the target point 1108 equidistant from both microphones in any pair. As a result, each half-hyperbola degrades to a straight line in two dimensions and in three-dimensions, each half-hyperboloid will degrade to the corresponding “vertical” plane. Intersection of three such planes is a line orthogonal to the microphone plane and intersects it at an equidistant point. In the three-dimensional case, the distance difference method can't discriminate between points lying on this line. This is another example of an axis of uncertainty.

1. A method of guiding an airborne vehicle towards a designated 3-dimensional location by collecting sound from a sound source associated with the airborne vehicle with a group of three microphones with known 3-dimensional vector representing the relative 3-dimensional position of the group of three microphones in relation to the designated 3-dimensional location, the method comprising:
receiving signals, from the sound source, at the group of three microphones, wherein the three microphones are logically connected with a computing device having a processor, nonvolatile storage, and a wireless transmitter, wherein the three microphones are configured as three microphones pairs for jointly processing each pair during distance difference estimations and calculating 3-dimensional locations;
calculating, with the computing device, a 3-dimensional vector representing the relative position of the airborne vehicle in relation to the group of microphones from the signals collected by the group of three microphones by way of distance difference estimation;
calculating, with the computing device, a 3-dimensional vector representing the relative position of the airborne vehicle in relation to the designated 3-dimensional location by applying vector addition to the vector representing the known relative position of the group of microphones in relation to the designated 3-dimensional location and the vector representing the relative position of the airborne vehicle in relation to the group of three microphones;
sending, by the wireless transmitter, the 3-dimensional vector representing the relative 3-dimensional position of the airborne vehicle in relation to the designated 3-dimensional location of the airborne vehicle to the airborne vehicle for the purpose of calculating, at the airborne vehicle, the control parameters to decrease the distance between the airborne vehicle and the designated 3-dimensional location, and for applying these calculated control parameters to the vehicle management system; and
repeating the receiving, calculating, and sending after the airborne vehicle has changed position.

2. The method of claim 1, wherein the three microphones are installed at or near a landing site.

3. The method of claim 1, wherein the sound source is a first sound source with a first sound signature and the airborne vehicle comprises a second sound source with a second sound signature, and the 3-dimensional location of the first and second sound sources are calculated separately.

4. The method of claim 1, further comprising sending, with the wireless transmitter, a request to the airborne vehicle to change position in any direction, when a position of the airborne vehicle on the z-axis cannot be calculated because the sound source is equidistant from the three microphones.

5. The method of claim 3, further comprising:
constructing the 3-dimensional position of the airborne vehicle,
wherein three microphones capture the signals from the first and second sound sources;
wherein the z-coordinate of one of the first or second sound sources cannot be calculated because of equidistance from the three microphones; and
wherein the 3-dimensional location of the airborne vehicle (X0, Y0, Z0) is calculated from the locations of the first and second sound sources by using a known z-coordinate to reconstruct the z-coordinate that cannot be calculated.

6. The method of claim 3, wherein the first sound source has a first sound signature and the second sound source has a second sound signature, and the first and second sound signatures are stored by the computing device and further comprising calculating the z-coordinate of the airborne vehicle using the stored first and second sound signatures when a position of airborne vehicle on the z-axis cannot be calculated because one of the first or second sound sources is equidistant to the three microphones.

7. The method of claim 1, wherein the airborne vehicle receives 3-dimensional location information by way of a radio, a light, or a sound signal.

8. The method of claim 1, wherein a fourth microphones receives signals from the sound source.

9. The method of claim 8, wherein more than four microphones are used to receive sound signals from the sound source.

10. A method of guiding an airborne vehicle by collecting sound from a sound source associated with the airborne vehicle with four microphones, the method comprising:
receiving signals, from the sound source, at the four microphones positioned so that there is no point equidistant to the four microphones;
wherein the four microphones are logically connected with a computing device having a processor, nonvolatile storage, and a wireless transmitter and wherein the four microphones are configured as four or more microphone pairs for jointly processing each pair during distance difference estimations and calculating 3-dimensional locations;
calculating, with the computing device, a 3-dimensional location of the airborne vehicle from the signals collected by the four microphones by way of distance difference estimation, the four microphones being configured as four or more microphone pairs for jointly processing each pair during distance difference estimation and for calculating the 3-dimensional location;
sending, by the wireless transmitter, the 3-dimensional location of the airborne vehicle to the airborne vehicle; and
repeating the receiving, calculating, and sending after the airborne vehicle has changed position.

11. The method of claim 10, wherein the four microphones are installed at or near a landing site.

12. The method of claim 10, wherein more than four microphones receive signals from the sound source.

13. The method of claim 10, wherein the airborne vehicle receives 3-dimensional location information by way of a radio, a light, or a sound signal.

14. A method of navigating an airborne vehicle by emitting sound from a sound source associated with the airborne vehicle for collection by three microphones, the method comprising:
emitting signals, from the sound source, for collection by the three microphones at or near a landing site, wherein the three microphones are logically connected with a computing device having a processor, nonvolatile storage, and a wireless transmitter, wherein, with the computing device, a 3-dimensional location of the airborne vehicle is calculated from the signals collected by the three microphones by way of distance difference estimation;
receiving, at the airborne vehicle, the 3-dimensional location of the airborne vehicle from the computing device;
changing the position of the airborne vehicle relative to the three microphones; and
repeating the emitting, receiving, and changing after the airborne vehicle has changed position.

15. The method of claim 14, wherein the sound source is a first sound source with a first sound signature and the airborne vehicle comprises a second sound source with a second sound signature.

16. The method of claim 15, wherein the sound source is equidistant from the three microphones and the 3-dimensional position of the airborne vehicle received by the airborne vehicle comprises X, Y, and Z coordinates calculated from the locations of the first and second sound sources by using a known z-coordinate to reconstruct a z-coordinate that cannot be calculated.

17. The method of claim 14, wherein the sound source is equidistant from the three microphones and the airborne vehicle changes position in response to a request from the computing device.

18. The method of claim 14, further comprising emitting signals for collection by four microphones.

19. The method of claim 18, further comprising emitting signals for collection by a fourth microphone and wherein the four microphones are positioned so that no equidistant point exists between the four microphones.

20. The method of claim 15, further comprising emitting signals for collection by more than four microphones.
